(19) United States
(12) Patent Application Publication
(10) Pub. No.: US 2008/0155996 A1
(43) Pub. Date: Jul. 3, 2008

(54) Process for vaporizing liquefied gas

(75) Inventors: Masroor S. Khan, The Woodlands, TX (US); David A. Coyle, Houston, TX (US); Charles A. Durr, Houston, TX (US)

Correspondence Address: KELLOGG BROWN & ROOT LLC;ATTN: Christian Heausler, 4100 Clinton Drive, HOUSTON, TX, 77020, US

(73) Assignee: Kellogg Brown & Root LLC

(21) Appl. No.: 11/646,027

(22) Filed: Dec. 27, 2006

(51) Int. Cl. F17C 9/02

(52) U.S. Cl. 62/50.2

(57) ABSTRACT

A process for vaporizing liquefied gas is provided. Energy can be transferred within one or more first heat exchangers from a heat transfer medium at a first temperature to a liquefied gas. At least a portion of the liquefied gas can be vaporized within the one or more first heat exchangers to provide an at least partially vaporized liquid and a heat transfer medium at a second temperature. The heat transfer medium can be heated from the second temperature to a temperature at or near the first temperature with air within one or more second heat exchangers. The heat transfer medium from the one or more second heat exchangers can be directed to the one or more first heat exchangers.

### BACKGROUND

1. Field

Embodiments herein generally relate to processes for vaporizing liquefied gas. More particularly, the embodiments relate to processes for vaporizing liquefied gas using gas fired vaporization systems.

2. Description of the Related Art

Submerged combustion vaporizers (SCV) have been used to vaporize liquefied natural gas (LNG). SVCs typically have a combustion chamber and tubes disposed within a bath of a heat transfer medium. A fuel gas is burned inside the combustion chamber to heat the heat transfer medium which exchanges heat with the LNG contained within the tubes, vaporizing the LNG. In certain systems, the vaporized LNG has been used as the fuel gas. Flue gases resulting from the combustion of the fuel gas are emitted into the heat transfer medium. The flue gases create turbulence within the heat transfer medium, increasing the heat exchange between the heat transfer medium and the LNG within the tubes. The turbulence is also useful in scrubbing the tubes, minimizing crystallization on the exterior surface of the tubes. For example, when the heat transfer medium is water, ice can form and deposit on the exterior surface of the tubes and inhibit heat transfer with the LNG inside the tubes. The turbulence from flue gases flowing within the heat transfer medium bath helps prevent ice formation on the exterior surface of the tubes.

The operation of SCVs presents both safety and environmental concerns. For example, the combustion chamber of the SCV is an ignition hazard due to the presence of an open flame in the presence of LNG, a flammable hydrocarbon. Therefore, extreme caution must be used to prevent fire or explosion. The pH level of the bath must also be maintained since the combination of the flue gas and heat transfer medium can form acidic by-products. In particular, the combination of the flue gas and water can form a significant quantity of NOₓ, CO₂, and other greenhouse gases which can be released to the atmosphere. Reducing those emissions can be difficult and expensive. Additional environmental concerns arise if other environmentally sensitive heat transfer mediums, such as those containing glycol, are used instead of water. Furthermore, SCVs typically consume 1-2% of the vaporized product as fuel gas, resulting in lost profits. A need exists for a more environmentally friendly and cost effective method for vaporizing LNG.

### BRIEF DESCRIPTION OF THE DRAWINGS

So that the manner in which the above recited features of the present embodiments can be understood in detail, a more particular description of the embodiments, briefly summarized above, may be had by reference to embodiments, some of which are illustrated in the appended drawings. It is to be noted, however, that the appended drawings illustrate only typical embodiments and are therefore not to be considered limiting of its scope, for the embodiments may admit to other equally effective embodiments.

FIG. 1 depicts an illustrative process for vaporizing liquefied gas according to one or more embodiments described.

FIG. 2 depicts another illustrative process for vaporizing liquefied gas according to one or more embodiments described.

FIG. 3 depicts still another illustrative process for vaporizing liquefied gas according to one or more embodiments described.

### DETAILED DESCRIPTION

A detailed description will now be provided. Each of the appended claims defines a separate embodiment, which for infringement purposes is recognized as including equivalents to the various elements or limitations specified in the claims. Depending on the context, all references below to the “embodiment” may in some cases refer to certain specific embodiments only. In other cases it will be recognized that references to the “embodiment” will refer to subject matter recited in one or more, but not necessarily all, of the claims. Each of the embodiments will now be described in greater detail below, including specific embodiments, versions and examples, but the embodiments are not limited to these embodiments, versions or examples, which are included to enable a person having ordinary skill in the art to make and use the embodiments, when the information in this patent is combined with available information and technology.

Processes for vaporizing liquefied gas are provided. In one or more embodiments, the process replaces or supplements the fuel gas consumption required to liquefy gas. In at least one embodiment, the process transfers energy from a heat transfer medium at a first temperature to a liquefied gas to at least partially vaporize the liquefied gas. The resulting heat transfer medium (“cooled heat transfer medium”) can be at least partially heated using a non-gas fired heat exchanger to a temperature at or near the first temperature and directed or returned to the first heat exchanger. In one or more embodiments, the resulting heat transfer medium (“cooled heat transfer medium”) can be at least partially heated to a temperature at or near the first temperature using a non-gas fired heat exchanger and a gas fired heat exchanger.

In one or more embodiments, the process replaces or supplements the fuel gas consumption required to operate a gas fired vaporization system, such as a submerged combustion vaporizer (SCV). In at least one embodiment, the process transfers energy from a heat transfer medium at a first temperature to a liquefied gas using a first heat exchanger, such as a gas fired vaporization system, to at least partially vaporize the liquefied gas. The resulting heat transfer medium (“cooled heat transfer medium”) exiting the first heat exchanger at a second temperature can be at least partially heated using a second heat exchanger, such as a non-gas fired system, to a temperature at or near the first temperature and directed or returned to the first heat exchanger.

The term “liquefied gas” as used herein refers to any gas that can be stored or transferred in a liquid phase. For example, the term “liquefied gas” includes, but is not limited to, liquefied natural gas (LNG), liquefied petroleum gas (LPG), liquefied energy gas (LEG), liquefied nitrogen, liquefied ethylene, natural gas liquid, liquefied methane, liquefied propane, liquefied butane, liquefied ammonia, combinations thereof and derivatives thereof.

The term “first temperature” as used herein, refers to a temperature suitable to at least partially vaporize the liquefied gas within the first heat exchanger. The first temperature can vary, depending upon the composition of the liquefied gas, and is greater than the temperature of the liquefied gas. As used herein, the term “temperature at or near the first temperature,” refers to a temperature that is within about 20° C. of the first temperature, or within about 15° C. of the first temperature, or within about 10° C. of the first temperature, or within about 5° C. of the first temperature, or within about 3° C. of the first temperature, or within about 2° C. of the first temperature, or within about 1° C. of the first temperature. In one or more embodiments, “at or near the first temperature” refers to a temperature that is within about 1° C. to about 5° C. of the first temperature, or within about 3° C. to about 10° C. of the first temperature, or within about 5° C. to about 20° C. of the first temperature.

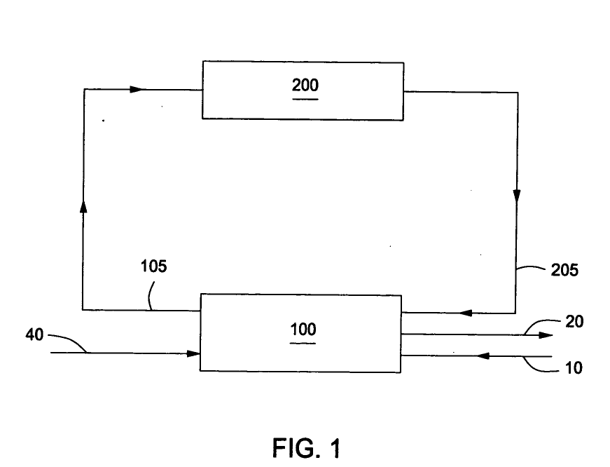

With reference to the Figures, FIG. 1 depicts an illustrative process for vaporizing liquefied gas according to one or more embodiments described. A liquefied gas stream to be vaporized, stream 10, is introduced to one or more first heat exchangers 100 containing a heat transfer medium at a first temperature. The liquefied gas stream 10 is at least partially vaporized within the one or more first heat exchangers 100 to provide an at least partially vaporized stream 20. The heat transfer medium having lost energy in exchange with the liquefied gas stream 10 (“cooled heat transfer medium”) exits the one or more first heat exchangers 100 as stream 105 at a second temperature. The stream 105 can be heated or re-heated using one or more second heat exchangers 200 to a temperature at or near the first temperature, providing a heated stream 205 containing the heat transfer medium having a temperature at or near the first temperature. The stream 205 having a temperature at or near the first temperature can be returned or otherwise directed to the one or more first heat exchangers 100 for further vaporization of the liquefied gas stream 10.

The first heat exchanger(s) 100 can be any type suitable for at least partially vaporizing the liquefied gas stream 10, including shell and tubes and combustion types. In one or more embodiments, the first heat exchanger 100 is or includes a gas fired vaporization system. Suitable gas fired vaporization systems include submerged combustion vaporizers (“SCV”), as exampled by the commercially available T-Thermal Sub-X® Vaporizer and Sumitomo SMv.

The second heat exchanger(s) 200 can be or include any non-gas fired system. Illustrative non-gas fired systems include but are not limited to a shell and tube types, plate types, regenerative types, air heaters, air blowers, or quench columns. In one or more embodiments, two or more second heat exchangers 200 can be arranged in parallel or series. If two or more second heat exchangers 200 are arranged in parallel or series, the second heat exchangers 200 can be any one or more shell and tube types, plate types, regenerative types, air heaters, air blowers, quench columns, or any combinations thereof. In one or more embodiments, the second heat exchangers 200 can be or include at least one gas-fired exchanger and at least one non-gas fired exchanger whereby the exchangers share or supplement the duty required to heat the heat transfer medium.

The liquefied gas stream 10 can include, but is not limited to, liquefied natural gas (LNG), liquefied petroleum gas (LPG), liquefied energy gas (LEG), liquefied ethylene, natural gas liquid, liquefied methane, liquefied propane, liquefied butane, liquefied ammonia, combinations thereof and derivatives thereof. In one or more embodiments, the liquefied gas stream 10 is or includes LNG. In one or more embodiments, the liquefied gas stream 10 can include of from 0 to about 10% (wt) N₂, 50% to about 100% (wt) CH₄, 0 to about 30% (wt) C₂H₆, 0 to about 30% (wt) C₃H₈, 0 to about 10% (wt) C4s, and/or 0 to about 10% (wt) C5 or heavier hydrocarbons.

The liquefied gas stream 10 entering the one or more first heat exchangers I00 can have a temperature ranging from a low of about −200° C., −175° C., or −165° C. to a high of about −165° C., −160° C., or −10° C. In one or more embodiments, the liquefied gas stream 10 can have a temperature ranging of from about −165° C. to about −160° C. In one or more embodiments, the liquefied gas stream 10 can have a temperature ranging of from about −160° C. to about −145° C.

The at least partially vaporized stream 20 exiting the one or more first heat exchangers 100 can have a temperature ranging of from a low of about −200° C., −10° C., or −5° C. to a high of about 0° C., 15° C., or 40° C. In one or more embodiments, the at least partially vaporized stream 20 can have a temperature ranging of from about −5° C. to about 25° C. In one or more embodiments, the at least partially vaporized stream 20 can have a temperature ranging of from about −1° C. to about 10° C.

In one or more embodiments, the at least partially vaporized stream 20 can be at least 50% vaporized. In one or more embodiments, the at least partially vaporized stream 20 can be at least 75% vaporized. The at least partially vaporized stream 20 can be at least 85%, 95%, or 99% vaporized. In one or more embodiments, the at least partially vaporized stream 20 is completely vaporized to 100% mol gas.

The heat transfer medium can be any fluid suitable for exchanging heat with the liquefied gas. For example, the heat transfer medium is or can include water, glycol, Paratherm CR®, Dowtherm®, Syltherm®, blends thereof, or derivatives thereof. In one or more embodiments, the heat transfer medium is or can include sea water.

The heat transfer medium within the stream 205 can exit the second heat exchanger 200 at a temperature at or near the first temperature. For example, the first temperature can range from a low of about −40° C., 0° C., or 5° C. to a high of about 0° C., 25° C., or 50° C. In one or more embodiments, the stream 205 can have a temperature at or near the first temperature ranging of from about 0° C. to about 40° C. In one or more embodiments, the stream 205 can have a temperature at or near the first temperature at about 20° C.

The heat transfer medium within the stream 105 exits the first heat exchanger 100 at a second temperature. The second temperature can be less (i.e. cooler) than the first temperature. The second temperature can range from a low of about 0° C., −5° C., or −10° C. to a high of about −5° C., 20° C., or 50° C. In one or more embodiments, the stream 105 can have a second temperature ranging of from about 15° C. to about 20° C. In one or more embodiments, the stream 105 can exit each first heat exchanger 100 having a second temperature at about 21° C.

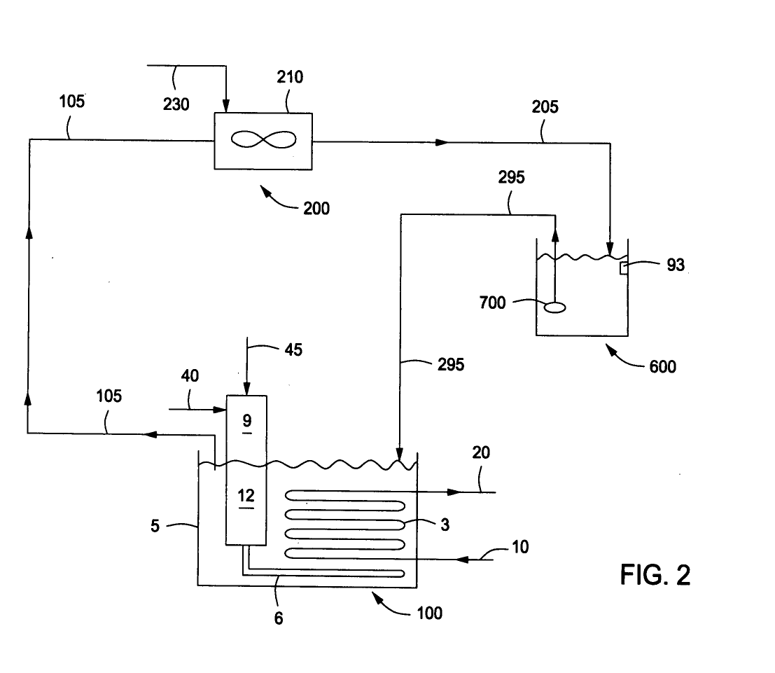

FIG. 2 depicts another illustrative process for vaporizing liquefied gas according to one or more embodiments described. In one or more embodiments, the heated stream 205 containing the heat transfer medium at a temperature at or near the first temperature can be collected in one or more sumps 600 and stored prior to introduction to each first heat exchanger 100. When needed, the heat transfer medium can be removed from the one or more sumps 600 via stream 295 and returned or otherwise directed to the first heat exchanger 100. The stream 295 can have a temperature at or near the first temperature. The sump 600 can be any type of sump suitable for collecting and storing the heat transfer medium. For example, each of the sumps 600 can be a PVC lined collection pond, an excavated area, a low lying area, a concrete containment device, a steel containment device, or any combination thereof.

In one or more embodiments, the first heat exchanger 100 can be a SCV. For example, the first heat exchanger 100 can include a housing 5, combustion chamber 9, burner 12, gas distributor 6, and tube 3. The heat transfer medium can be located or otherwise contained within the housing 5. The combustion chamber 9, gas distributor 6, and tube 3 can be partially or totally submerged within the heat transfer medium. The liquefied gas is in fluid communication with the tube 3 and flows therethrough.

The gas distributor 6 can be in fluid and/or thermal communication with the combustion chamber 9. The gas distributor 6 can be a part of the burner 12, a part of the combustion chamber 9, or independent of both. In one or more embodiments, the gas distributor 6 can be any suitable device or mechanism for distributing a gas. For example, the gas distributor 6 can include one or more baffles, weirs, plenums, orificed plates, sparger tubes, or any combination thereof.

In one or more embodiments, an oxygen-containing gas (“combustion gas”), such as air, can be introduced via stream 40 to the first heat exchanger 100. The gas distributor 6 can be used to evenly distribute the combustion gas through the heat transfer medium contained within the housing 5 and create turbulence therein. Turbulence in the heat transfer medium can increase the heat exchange between the heat transfer medium and the liquefied gas that flows through the tube 3. The turbulence is also useful in effectively scrubbing the exterior surface of the tube 3, minimizing or preventing heat transfer medium crystallization thereon. In one or more embodiments, combustion gas is emitted into the heat transfer medium within the one or more first heat exchangers 100.

Considering the second heat exchanger 200 in more detail, the second heat exchanger 200 can be or include an air heater 210 as depicted in FIG. 2. The air heater 210 can be any non-gas fired system suitable for heating the heat transfer medium. In one or more embodiments, the heat transfer medium via the stream 105 can be introduced into the one or more second heat exchangers 200 where the heat transfer medium is heated with air. The warmed heat transfer medium, having exchanged energy with the air, exits the second heat exchanger 200 in the stream 205.

In one or more embodiments, the heat transfer medium can be heated to a temperature at or near the first temperature using a combination of both the first and second heat exchangers 100, 200. For example, if the energy provided to the heat transfer medium by the second heat exchanger 200 is insufficient to at least partially vaporize the liquefied gas within the first heat exchanger 100, such as during cold ambient conditions or fluctuations in the liquefied gas feed, or if one of the one or more second heat exchangers 200 is taken off-line for maintenance or repair, energy can be supplemented by the first heat exchanger 100. Heat can be added to the heat transfer medium within the first heat exchanger 100 by combusting a fuel gas provided by stream 45. The fuel gas can be combusted within the first heat exchanger 100 and the resulting heat directed to the heat transfer medium, the tube 3, and/or the liquefied gas within the first heat exchanger 100.

In one or more embodiments, the fuel gas combusted within the first heat exchanger 100 produces a flue gas which can create turbulence within the heat transfer medium. The turbulence generated by the flue gas emitted within the first heat exchanger 100 can be used to scrub the exterior surface of the tubes and prevent crystallization thereon. Therefore, in one or more embodiments, a fuel gas can be combusted within the first heat exchanger 100 to scrub the tube 3 and increase the heat transfer between the liquefied gas within the tube 3 and the heat transfer medium.

In one or more embodiments, the one or more heat exchangers 200 can provide 80%, 90%, 95%, 99%, or 100% of the total energy required to at least partially vaporize the liquefied gas. In one or more embodiments, the first heat exchanger 100 can provide energy (i.e. heat) to provide at least 3%, 5%, 10%, 15%, or 20% of the total energy required to at least partially vaporize the liquefied gas. In one or more embodiments, the first heat exchanger 100 and the second heat exchanger 200 can each provide 50% of the total energy required to at least partially vaporize the liquefied gas. In one or more embodiments, the second heat exchanger 200 provides 100% of the total energy required to at least partially vaporize the liquefied gas and the first heat exchanger 100 combusts fuel gas to generate turbulence for scrubbing the exterior surface of the tube 3. Supplementing the energy provided to the heat transfer medium by the second heat exchanger 200 with energy from the first heat exchanger 100 provides flexibility to the process of vaporizing.

As mentioned, the heated stream 205 containing the heat transfer medium at a temperature at or near the first temperature can be collected in one or more sumps 600 and stored prior to introduction to each first heat exchanger 100. In one or more embodiments, one or more sump pumps 700 can be used to transfer the heat transfer medium via stream 295 from the one or more sumps 600 to the one or more first heat exchangers 100. The sump pumps 700 can be any pump suitable for pumping a heat transfer medium, including positive displacement pumps, such as reciprocating or rotary, or dynamic pumps. For example, the sump pumps 700 can be a Webster® Marathon Seal-Less submersible pump.

In one or more embodiments, the sump 600 can provide an additional opportunity to monitor/control the pH level of the heat transfer medium over single stage SCV pH monitor/control. The one or more pH control devices 93 can be used to monitor or control the pH level of the heat transfer medium in the one or more sumps 600. In one or more embodiments, each pH control device 93 can be a one way or two way neutralization pH control device. In one or more embodiments, each pH control device 93 can be a skid mounted sampler or in-situ pH control device. In one or more embodiments, each pH control device 93 can be a remote controlled device or an automatic calibrating device like the AutoCalibrate™ from ChemIndustrial.

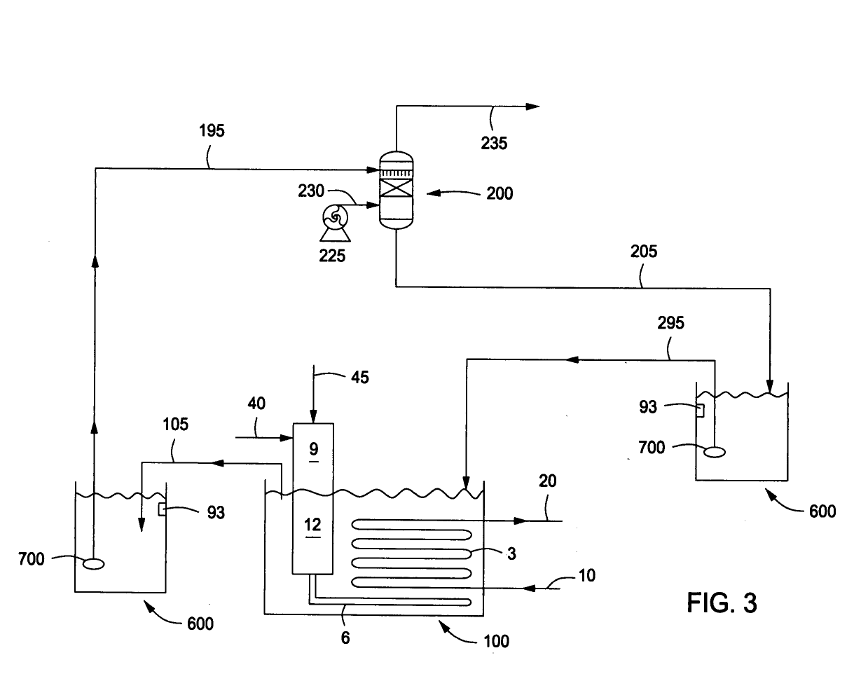

FIG. 3 depicts still another illustrative process for vaporizing liquefied gas according to one or more embodiments described. In one or more embodiments, at least one first heat exchanger 100 can be or include a SCV and at least one second heat exchanger 200 can be or include a quench column 270. Within each quench column 270, the heat transfer medium exchanges heat with air in stream 230 provided by one or more air blowers 225. The heat transfer medium from the one or more heat exchangers 100 can be collected via stream 105 in one or more sumps 600. If needed, the heat transfer medium can be removed from the one or more sumps 600 via stream 195 and returned or otherwise directed to the one or more first heat exchangers 100. The heat transfer medium from the one or more second exchangers 200 can be collected via stream 205 in one or more sumps 600. If needed, the heat transfer medium can be removed from the one or more sumps 600 via stream 295 and returned or otherwise directed to the one or more second heat exchangers 200. As mentioned, one or more sump pumps 700 can be used to transfer the heat transfer medium from the sumps 600.

The quench column 270 can include packing media so as to provide surface area for the air and heat transfer medium to make thermal contact. The packing media can be any suitable device that provides surface area for any two heat transfer media to make thermal contact, including: rings, saddles, balls, irregular sheets, tubes, spirals, trays, and baffles.

The air blower 225 can provide air to the quench column 270 to facilitate heat exchange between the air and the heat transfer medium. Any suitable air blower can be used. Illustrative air blowers can include, but are not limited to, a centrifugal blower, a co-axial blower, a vane-axial blower, or a belt driven or direct driven blower.

The heat transfer medium stream 195 exiting the one or more sumps 600 can be at a temperature ranging from a low of about −50° C., −5° C., or 0° C. to a high of about −5° C., 20° C., or 50° C. In one or more embodiments, the stream 195 can be at a temperature ranging of from about 0° C. to about 20° C. In one or more embodiments, the stream 195 can be at a temperature ranging of from about 15° C. to about 21° C.

The flow design and the use of ambient air for heating the heat transfer medium results in lower capital costs, reduced fuel costs, and ease of operation over existing vaporization processes, especially those using gas fired vaporization systems.

Specific embodiments can further include a process for vaporizing liquefied gas, comprising: transferring energy within one or more first heat exchangers from a heat transfer medium at a first temperature to a liquefied gas, wherein at least one of the one or more first heat exchangers is a gas fired vaporizer; vaporizing at least a portion of the liquefied gas within the one or more first heat exchangers to provide an at least partially vaporized liquid and a heat transfer medium at a second temperature; heating the heat transfer medium from the second temperature to a temperature at or near the first temperature with air within one or more second heat exchangers; and directing the heat transfer medium from the one or more second heat exchangers to the one or more first heat exchangers.

Specific embodiments can further include the process of paragraph [0038] and one or more of the following embodiments: the gas fired vaporizer is a furnace heater; the gas fired vaporizer is a SCV; at least one of the one or more second heat exchangers is a non-gas fired heat exchanger; the one or more second heat exchangers is selected from the group consisting of air heaters, quench towers, or combinations thereof; and/or the liquefied gas is liquefied natural gas.

Specific embodiments can further include a process for vaporizing liquefied gas, comprising: transferring energy within one or more first heat exchangers from a heat transfer medium at a first temperature to a liquefied gas, wherein at least one of the one or more first heat exchangers comprises: a combustion chamber, burner, and tube, the tube at least partially submerged within the heat transfer medium; vaporizing at least a portion of the liquefied gas within the one or more first heat exchangers to provide an at least partially vaporized liquid and a heat transfer medium at a second temperature; and heating the heat transfer medium from the second temperature to a temperature at or near the first temperature with air within one or more second heat exchangers; and directing the heat transfer medium from the one or more second heat exchangers to the one or more first heat exchangers.

Specific embodiments can further include the process of paragraph [0040] and one or more of the following embodiments: directing the heat transfer medium from the one or more first heat exchangers to one or more sumps prior to heating the heat transfer medium within the one or more second heat exchangers; directing the heat transfer medium from the one or more second heat exchangers to one or more sumps prior to directing the heat transfer medium to the one or more first heat exchangers; creating turbulence within the one or more first heat exchangers by introducing a gas directly into the heat transfer medium and using the turbulence to scrub the tube; utilizing a pH control device on at least one sump to monitor or maintain pH level of the heat transfer medium; utilizing a pH control device on at least one sump to monitor or maintain pH level of the heat transfer medium; and/or adding heat to the heat transfer medium by combusting fuel gas within the combustion chamber of at least one of the one or more first heat exchangers; wherein the combustion chamber is at least partially submerged within the heat transfer medium within the at least one of the one or more first heat exchangers; wherein at least one of the one or more first heat exchangers is a SCV; wherein at least one of the one or more second heat exchangers is a non-gas fired heat exchanger; wherein at least one of the one or more second heat exchangers is an air heater or a quench tower; and/or wherein the liquefied gas is liquefied natural gas.

Specific embodiments can further include a process for vaporizing liquefied gas, comprising: transferring energy within one or more first heat exchangers from a heat transfer medium to a liquefied gas, wherein at least one of the one or more first heat exchangers comprises: a combustion chamber, burner, and tube, the tube at least partially submerged within the heat transfer medium; vaporizing at least a portion of the liquefied gas in the one or more first heat exchangers to provide an at least partially vaporized liquid and a heat transfer medium at a second temperature; directing the heat transfer medium to one or more first sumps; heating the heat transfer medium from the second temperature to a temperature at or near the first temperature with air within at least one second heat exchanger selected from an air heater or quench column; directing the heat transfer medium from the at least one second heat exchanger to one or more second sumps; and directing the heat transfer medium from the one or more second sumps to the one or more first heat exchangers.

Specific embodiments can further include the process of paragraph [0042], wherein the at least one second heat exchanger is or includes a quench column having an air blower in fluid communication therewith.

Certain embodiments and features have been described using a set of numerical upper limits and a set of numerical lower limits. It should be appreciated that ranges from any lower limit to any upper limit are contemplated unless otherwise indicated. Certain lower limits, upper limits and ranges appear in one or more claims below. All numerical values are “about” or “approximately” the indicated value, and take into account experimental error and variations that would be expected by a person having ordinary skill in the art.

Various terms have been defined above. To the extent a term used in a claim is not defined above, it should be given the broadest definition persons in the pertinent art have given that term as reflected in at least one printed publication or issued patent. Furthermore, all patents, test procedures, and other documents cited in this application are fully incorporated by reference to the extent such disclosure is not inconsistent with this application and for all jurisdictions in which such incorporation is permitted.

While the foregoing is directed to embodiments, other and further embodiments may be devised without departing from the basic scope thereof, and the scope thereof is determined by the claims that follow.

What is claimed is:

1) A process for vaporizing liquefied gas, comprising:
transferring energy within one or more first heat exchangers from a heat transfer medium at a first temperature to a liquefied gas, wherein at least one of the one or more first heat exchangers is a gas fired vaporizer;
vaporizing at least a portion of the liquefied gas within the one or more first heat exchangers to provide an at least partially vaporized liquid and a heat transfer medium at a second temperature;
heating the heat transfer medium from the second temperature to a temperature at or near the first temperature with air within one or more second heat exchangers; and
directing the heat transfer medium from the one or more second heat exchangers to the one or more first heat exchangers.

2) The process of claim 1, wherein the gas fired vaporizer is a furnace heater.

3) The process of claim 1, wherein the gas fired vaporizer is a SCV.

4) The process of claim 1, wherein at least one of the one or more second heat exchangers is a non-gas fired heat exchanger.

5) The process of claim 1, wherein the one or more second heat exchangers is selected from the group consisting of air heaters, quench towers, and combinations thereof.

6) The process of claim 1, wherein the liquefied gas is liquefied natural gas.

7) A process for vaporizing liquefied gas, comprising:
transferring energy within one or more first heat exchangers from a heat transfer medium at a first temperature to a liquefied gas, wherein at least one of the one or more first heat exchangers comprises: a combustion chamber, burner, and tube, the tube at least partially submerged within the heat transfer medium;
vaporizing at least a portion of the liquefied gas within the one or more first heat exchangers to provide an at least partially vaporized liquid and a heat transfer medium at a second temperature; and
heating the heat transfer medium from the second temperature to a temperature at or near the first temperature with air within one or more second heat exchangers; and
directing the heat transfer medium from the one or more second heat exchangers to the one or more first heat exchangers.

8) The process of claim 7, further comprising directing the heat transfer medium from the one or more first heat exchangers to one or more sumps prior to heating the heat transfer medium within the one or more second heat exchangers.

9) The process of claim 8, further comprising utilizing a pH control device on at least one sump to monitor or maintain pH level of the heat transfer medium.

10) The process of claim 7, further comprising utilizing a pH control device on at least one sump to monitor or maintain pH level of the heat transfer medium.

11) The process of claim 7, further comprising directing the heat transfer medium from the one or more second heat exchangers to one or more sumps prior to directing the heat transfer medium to the one or more first heat exchangers.

12) The process of claim 7, further comprising creating turbulence within the one or more first heat exchangers by introducing a gas directly into the heat transfer medium and using the turbulence to scrub the tube.

13) The process of claim 7, further comprising adding heat to the heat transfer medium by combusting fuel gas within the combustion chamber of at least one of the one or more first heat exchangers.

14) The process of claim 7, wherein the combustion chamber is at least partially submerged within the heat transfer medium within the at least one of the one or more first heat exchangers.

15) The process of claim 7, wherein at least one of the one or more first heat exchangers is a scv.

16) The process of claim 7, wherein at least one of the one or more second heat exchangers is a non-gas fired heat exchanger.

17) The process of claim 7, wherein at least one of the one or more second heat exchangers is an air heater or quench tower.

18) The process of claim 7, wherein the liquefied gas is liquefied natural gas.

19) A process for vaporizing liquefied gas, comprising:
transferring energy within one or more first heat exchangers from a heat transfer medium to a liquefied gas, wherein at least one of the one or more first heat exchangers comprises: a combustion chamber, burner, and tube, the tube at least partially submerged within the heat transfer medium;
vaporizing at least a portion of the liquefied gas in the one or more first heat exchangers to provide an at least partially vaporized liquid and a heat transfer medium at a second temperature;
directing the heat transfer medium to one or more first sumps;
heating the heat transfer medium from the second temperature to a temperature at or near the first temperature with air within at least one second heat exchanger selected from an air heater or quench column;
directing the heat transfer medium from the at least one second heat exchanger to one or more second sumps; and
directing the heat transfer medium from the one or more second sumps to the one or more first heat exchangers.

20) The process of claim 19, wherein the at least one second heat exchanger is or includes a quench column having an air blower in fluid communication therewith.
